(19) United States
(12) Patent Application Publication
(10) Pub. No.: US 2013/0328794 A1
(43) Pub. Date: Dec. 12, 2013

(54) TOUCH DISPLAY MODULE

(71) Applicants: Ching-Mu Cheng, Hsinchu City (TW); Shih-Chang Chen, Kinmen County (TW); Hung-Yi Ou Yang, Taoyuan County (TW)

(72) Inventors: Ching-Mu Cheng, Hsinchu City (TW); Shih-Chang Chen, Kinmen County (TW); Hung-Yi Ou Yang, Taoyuan County (TW)

(73) Assignee: CHUNGHWA PICTURE TUBES, LTD., Taoyuan (TW)

(21) Appl. No.: 13/592,345

(22) Filed: Aug. 23, 2012

(30) Foreign Application Priority Data
Jun. 7, 2012 (TW) 101211020

(51) Int. Cl. G06F 3/041

(52) U.S. Cl. 345/173

(57) ABSTRACT

A touch display module includes a display device and a first panel. The display device includes a display panel, a frame surrounding the display panel, and at least two first positioning parts disposed on the frame. The first panel is disposed on the display device. The first panel includes a protection plate and at least two second positioning parts disposed on the protection plate. The first positioning parts are combined with the second positioning parts to fix relative locations of the first panel and the display device.

### CROSS-REFERENCE TO RELATED APPLICATION

This application claims the priority benefit of Taiwan application serial no. 101211020, filed on Jun. 7, 2012. The entirety of the above-mentioned patent application is hereby incorporated by reference herein and made a part of this specification.

### BACKGROUND OF THE INVENTION

1. Field of Invention

The invention relates to a display module. More particularly, the invention relates to a touch display module.

2. Description of Related Art

Information technologies (ITs), wireless mobile communications, and information home appliances have been rapidly developed and extensively applied. To meet current demands on portable, compact, and user-friendly IT products, touch devices have been introduced as input devices in replacement of conventional input devices, such as keyboards or mice. A touch panel characterized by its user-friendly operational interface has been widely employed in various types of electronic products, especially mobile electronic products (e.g., cell phones, tablet PCs, and so forth). Based on the sensing principles, the touch panels may be categorized into resistive touch panels, capacitive touch panels, and optical touch panels. Among the touch panels, the capacitive touch panels are capable of achieving favorable sensing effects and thus have become the mainstream touch panels at present.

In general, a touch display device mainly includes a display device and a touch panel. During assembly of the touch display device, a set of assembling fixtures is often utilized to position the touch panel and the display device, and the touch panel and the display device are adhered to each other by using a double-sided tape. Manufacture of touch display devices with different sizes requires respective assembling fixtures, and the manufacturing tolerance of the assembly fixtures and the labor hours spent on the assembly with use of the fixtures frequently increase the production costs. Moreover, once the fixture tolerance is excessively high, abnormal alignment between the display device and the touch panel is apt to occur, which may lead to misalignment of the display area or exposure of chip traces in the display device.

### SUMMARY OF THE INVENTION

The invention is directed to a touch display module with favorable assembly yield.

In an embodiment of the invention, a touch display module that includes a display device and a first panel is provided. The display device includes a display panel, a frame surrounding the display panel, and at least two first positioning parts disposed on the frame. The first panel is disposed on the display device, and the first panel includes a protection plate and at least two second positioning parts disposed on the protection plate. The first positioning parts are respectively combined with the second positioning parts, so as to fix relative locations of the first panel and the display device.

According to an embodiment of the invention, the first positioning parts are protrusions that extend toward the first panel, and the second positioning parts are recesses corresponding to the protrusions.

According to an embodiment of the invention, the first panel further includes a touch sensing layer that is located between the protection plate and the display device.

According to an embodiment of the invention, the display panel includes an active device substrate, an opposite substrate opposite to the active device substrate, a display medium layer located between the active device substrate and the opposite substrate, and a touch sensing layer located between the opposite substrate and the display medium layer.

According to an embodiment of the invention, the display panel includes an active device substrate, an opposite substrate opposite to the active device substrate, a display medium layer located between the active device substrate and the opposite substrate, and a touch sensing layer, and the opposite substrate is located between the touch sensing layer and the display medium layer.

According to an embodiment of the invention, the display panel includes an active device substrate, an opposite substrate opposite to the active device substrate, a display medium layer located between the active device substrate and the opposite substrate, and a touch sensing layer located between the active device substrate and the display medium layer.

According to an embodiment of the invention, the protection plate has a first surface and a second surface opposite to the first surface, and the first surface is located between the display device and the second surface. The recesses penetrate the first surface and extend toward the second surface, but the recesses do not penetrate the second surface.

According to an embodiment of the invention, the recesses penetrate the protection plate.

According to an embodiment of the invention, the touch display module further includes a plurality of shields. The shields are disposed on the second surface of the protection plate, and the shields respectively cover the recesses.

According to an embodiment of the invention, each of the first positioning parts includes a first positioning sub-part and a second positioning sub-part. The first positioning sub-part connects the second positioning sub-part and the frame. The maximum diameter of the second positioning sub-part is greater than the maximum diameter of the first positioning sub-part.

According to an embodiment of the invention, the first positioning sub-part is a pillar, and the second positioning sub-part has a bottom surface directly connected to the pillar, a top surface opposite to the bottom surface, and a circumferential surface that surrounds and connects the top surface and the bottom surface. An area of the bottom surface is greater than an area of the top surface. A cross-sectional area of the pillar cut by a reference plane is smaller than the area of the bottom surface, and the reference plane is parallel to a display surface of the display device.

According to an embodiment of the invention, a cross-sectional area of the second positioning sub-part cut by the reference plane is gradually reduced together with the reference plane moving away from the display device.

According to an embodiment of the invention, each of the second positioning parts includes a third positioning sub-part and a fourth positioning sub-part. The third positioning sub-part is located between the fourth positioning sub-part and the display device, and the maximum caliber of the fourth positioning sub-part is greater than the maximum caliber of the third positioning sub-part.

According to an embodiment of the invention, the first positioning sub-part is lodged in the third positioning sub-part, and the second positioning sub-part is lodged in the fourth positioning sub-part.

According to an embodiment of the invention, each of the first positioning parts includes a base and a plurality of fasteners connected to the base. At least one flexible space exists among the fasteners.

According to an embodiment of the invention, the base is lodged in the third positioning sub-part, and the fasteners are lodged in the fourth positioning sub-part.

According to an embodiment of the invention, the first positioning parts are recesses that extend toward the first panel, and the second positioning parts are protrusions corresponding to the recesses.

According to an embodiment of the invention, the touch display module further includes an adhesive. The adhesive is disposed between the display device and the first panel. Besides, the adhesive is suitable for adhering the first panel to the display device.

According to an embodiment of the invention, the adhesive is a double-sided tape, a hydro-gel, or a combination thereof

In view of the above, during assembly of the touch display module described herein, abnormal alignment between the first panel and the display device is not prone to occur if the first positioning parts and the second positioning parts are applied, and thereby the assembly yield of the touch display module described herein may be improved.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1A and FIG. 1B are a three-dimensional view and an exploded view illustrating a touch display module according to an embodiment of the invention.

FIG. 1C and FIG. 1D are partial enlarged views respectively illustrating the first positioning part and the second positioning part depicted in FIG. 1B.

FIG. 2A to FIG. 2C are cross-sectional views illustrating a touch display module according to other embodiments of the invention.

FIG. 3A and FIG. 3B are partial enlarged views respectively illustrating the first positioning part and the second positioning part of the touch display module according to an embodiment of the invention.

FIG. 4A is a cross-sectional view illustrating the first positioning part depicted in FIG. 1C and taken along a line segment A-A′.

FIG. 4B is a cross-sectional view illustrating the second positioning part depicted in FIG. 1D and taken along a line segment B-B′.

FIG. 5 is a cross-sectional view illustrating the touch display module depicted in FIG. 1A and taken along a line segment I-I′.

FIG. 6A is a cross-sectional view illustrating a touch display module according to another embodiment of the invention.

FIG. 6B is a cross-sectional view illustrating that the first panel depicted in FIG. 6A is assembled to a display device.

FIG. 7A and FIG. 7B are respectively a three-dimensional view illustrating a touch display module according to yet another embodiment of the invention and a cross-sectional view taken along a line segment C-C′.

FIG. 8A to FIG. 8C are cross-sectional views illustrating a process of assembling the first panel to the display device depicted in FIG. 7A.

### DETAILED DESCRIPTION OF DISCLOSED EMBODIMENTS

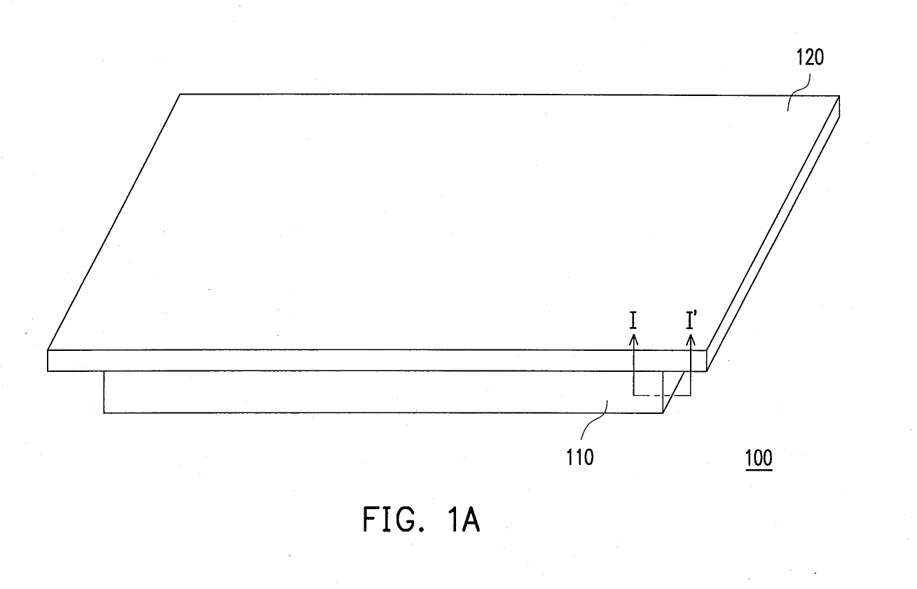

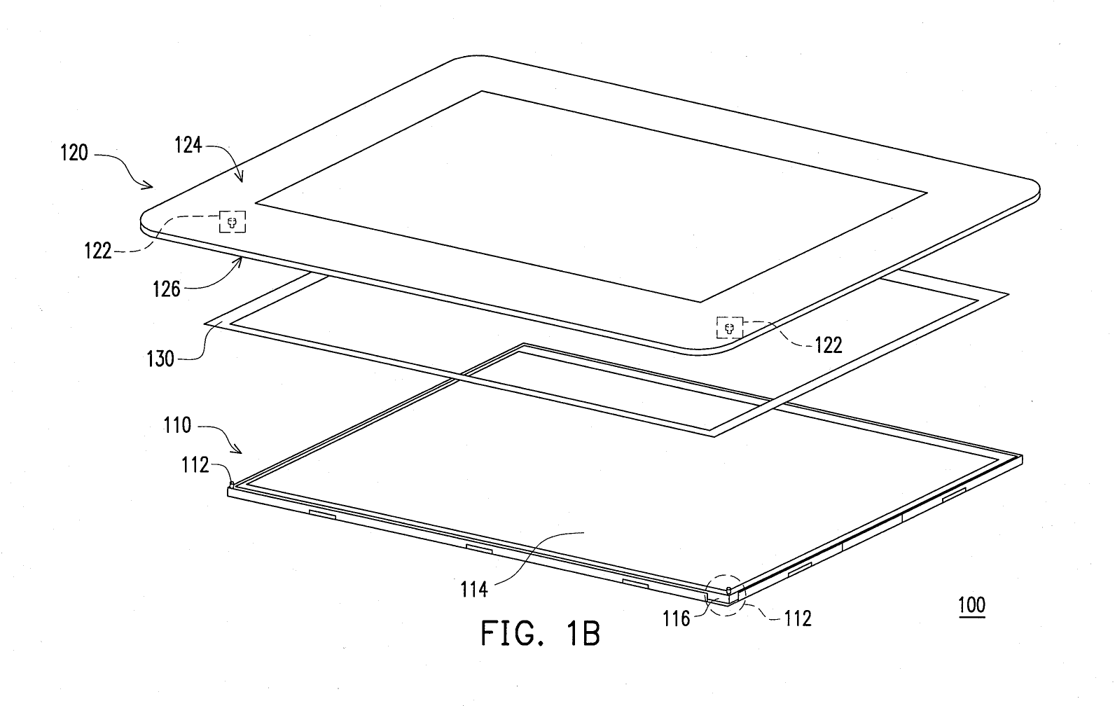

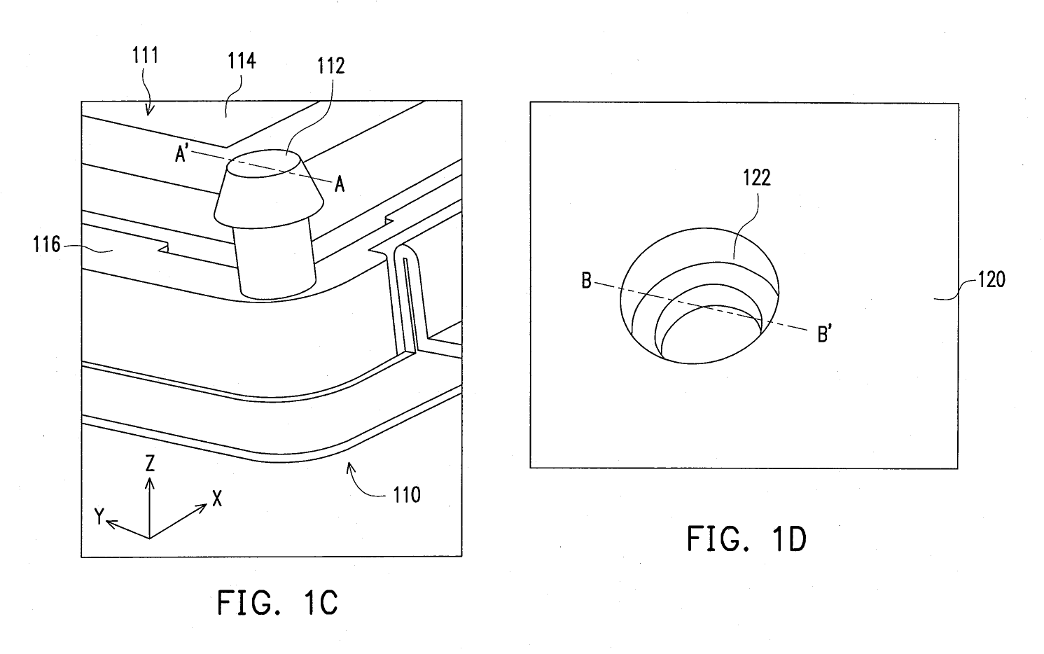

FIG. 1A is a cross-sectional view illustrating a touch display module according to an embodiment of the invention. FIG. 1B is an exploded view of FIG. 1A. FIG. 1C and FIG. 1D are partial enlarged views respectively illustrating the first positioning part and the second positioning part depicted in FIG. 1B. With reference to FIG. 1A to FIG. 1D, the touch display module 100 described herein includes a display device 110 and a first panel 120. The display device 110 includes at least two first positioning parts 112. The first panel 120 is disposed on the display device 110. Besides, the first panel 120 includes at least two second positioning parts 122. The first positioning parts 112 are combined with the second positioning parts 122 to fix relative locations of the first panel 120 and the display device 110. Thereby, abnormal alignment between the first panel 120 and the display device 110 is not apt to occur during the assembly of the touch display module 100. Besides, on account of the first positioning part 112 and the second positioning part 122, the labor hours spent on adhering the display device 100 to the first panel 120 may be effectively reduced.

The display device 110 described in the present embodiment includes a display panel 114 and a frame 116. In the present embodiment, the first panel 120 includes a protection plate 124 and a touch sensing layer 126 disposed on the protection plate 124, and the touch sensing layer 126 is located between the protection plate 124 and the display device 110. The touch sensing layer 126 may be directly connected to the protection plate 124, and therefore the first panel 120 described in the present embodiment may be considered as a touch panel. Here, the protection plate 124 is a rigid substrate, for instance, which should not be construed as a limitation to the invention.

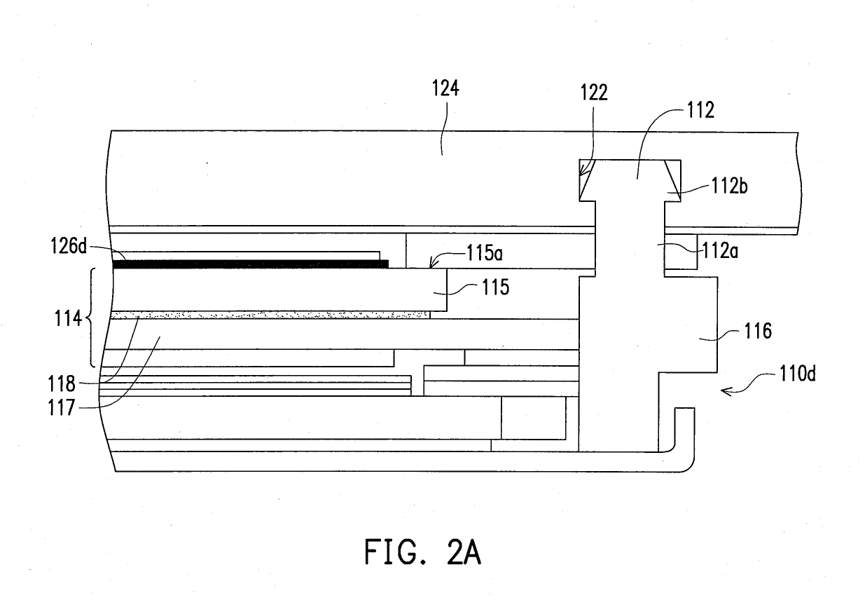

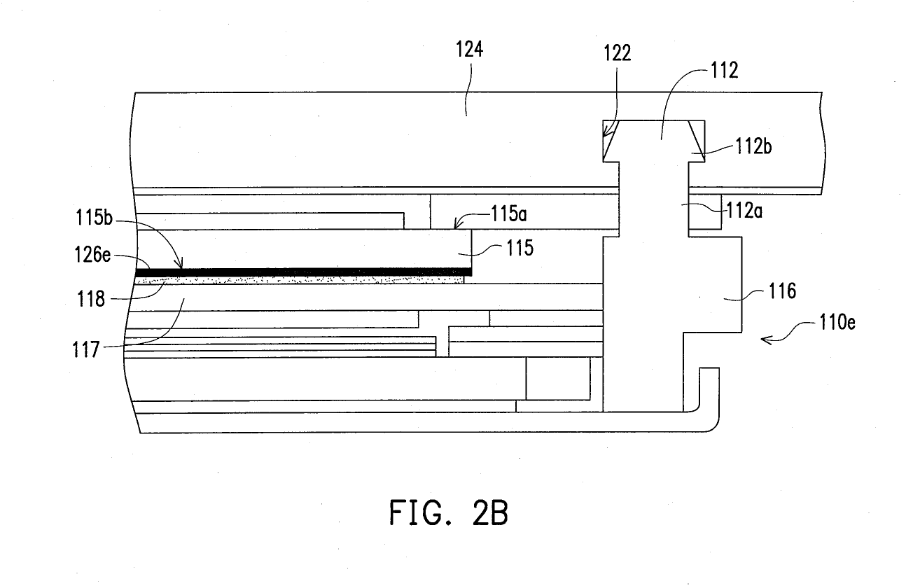

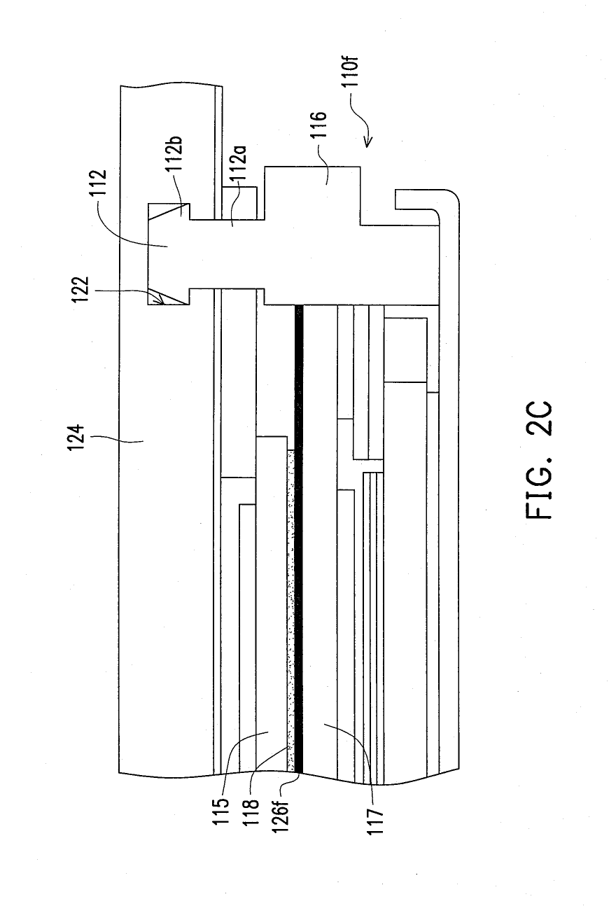

The relative location of the touch sensing layer in the display module may be changed if the design of the display module is altered, which is explained in the following embodiments. FIG. 2A, FIG. 2B, and FIG. 2C are cross-sectional views illustrating a touch display module according to other embodiments of the invention. With reference to FIG. 2A, the display panel 110d includes an active device substrate 117, an opposite substrate 115 opposite to the active device substrate 117, a display medium layer 118 located between the active device substrate 117 and the opposite substrate 115, and a touch sensing layer 126d. In the present embodiment, the opposite substrate 115 is located between the touch sensing layer 126d and the display medium layer 118, and the touch sensing layer 126d is disposed on an upper surface 115a of the opposite substrate 115. In the embodiment shown in FIG. 2B, the touch sensing layer 126e of the display device 110e is located between the opposite substrate 115 and the display medium layer 118. Namely, the touch sensing layer 126e is disposed on a lower surface 115b of the opposite substrate 115, and the lower surface 115b is opposite to the upper surface 115a. In the embodiment shown in FIG. 2C, the touch sensing layer 126f of the display device 110f is located between the active device substrate 117 and the display medium layer 118. As shown in FIG. 2B and FIG. 2C, the touch sensing layers 126e and 126f described herein are both disposed in the display device. Since the touch sensing layer described in the previous embodiments is disposed in the display device, the first panel disposed outside the display device merely has a protection plate.

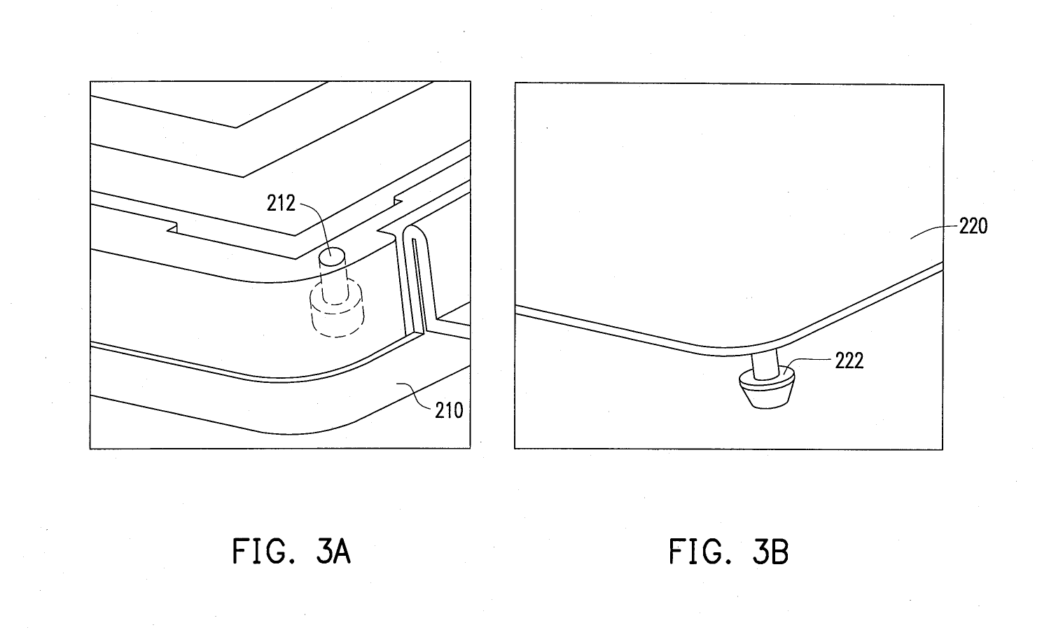

In the present embodiment, the first positioning parts 112 may be disposed on the frame 116 of the display device 110. To be specific, the first positioning parts 112 and the frame 116 may be made of the same material. The second positioning parts 122 may be formed on the protection plate 124 of the first panel 120. According to the present embodiment, the first positioning parts 112 are protrusions that extend toward the first panel 120, and the second positioning parts 122 are recesses corresponding to the protrusions. However, the first positioning parts on the display device are not limited to be protrusions, and nor are the second positioning parts on the first panel limited to be recesses. This will be discussed with reference to the following embodiment. FIG. 3A and FIG. 3B are partial enlarged views respectively illustrating the first positioning part and the second positioning part of the touch display module according to another embodiment of the invention. According to the present embodiment, the second positioning parts 222 may be protrusions that extend toward the display device 210, and the first positioning parts 212 may be recesses corresponding to the protrusions. The first positioning parts 212 are combined with the second positioning parts 222 to fix relative locations of the first panel 220 and the display device 210.

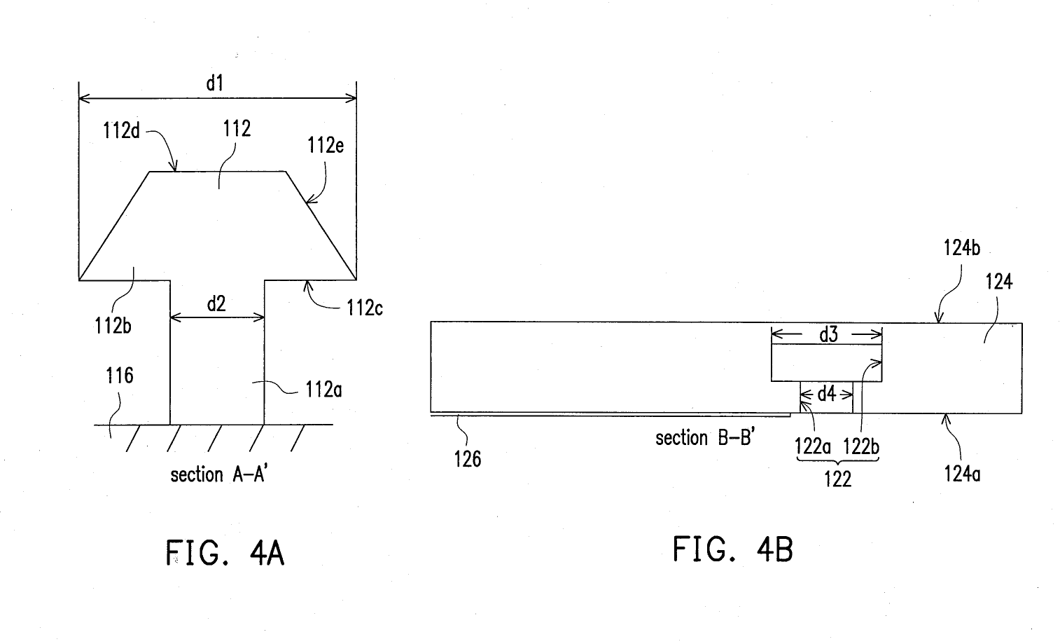

The design of the positioning parts will be elaborated hereinafter. The embodiments shown in FIG. 1A and FIG. 1D serve to describe the invention, while the invention does not pose limitations to the design of the positioning parts. FIG. 4A is a cross-sectional view taken along a line segment A-A′ of FIG. 1C. FIG. 4B is a cross-sectional view taken along a line segment B-B′ of FIG. 1D. In FIG. 4A, the first positioning parts 112 are protrusions, and each of the first positioning parts 112 includes a first positioning sub-part 112a and a second positioning sub-part 112b. The first positioning sub-part 112a connects the second positioning sub-part 112b and the frame 116. The maximum diameter d1 of the second positioning sub-part 112b is greater than the maximum diameter d2 of the first positioning sub-part 112a. Particularly, the first positioning sub-part 112a may be a pillar, and the second positioning sub-part 112b appears to be a frustum. The second positioning sub-part 112b has a bottom surface 112c directly connected to the first positioning sub-part 112a, a top surface 112d opposite to the bottom surface 112c, and a circumferential surface 112e surrounding and connecting the top surface 112d and the bottom surface 112c. In the present embodiment, an area of the bottom surface 112c is greater than an area of the top surface 112d. Besides, a cross-sectional area of the first positioning sub-part 112a cut by a reference plane is smaller than the area of the bottom surface 112c. The reference plane herein refers to a plane parallel to an X-Y plane shown by the coordinate axes in FIG. 1 C. The plane is parallel to a display surface 111 of the display device 110, and the display surface 111 refers to the plane where the display panel 114 is located. As a whole, the second positioning sub-part 112b described herein has a shape similar to a mushroom head. Namely, as the distance between the reference plane and the display device 110 increases (the reference plane is moved away from the display device 110 along the positive Z-axis direction), the cross-sectional area of the second positioning sub-part 112b cut by the reference plane is reduced little by little.

By contrast, the second positioning parts 122 corresponding to the first positioning parts 112 are described hereinafter. In FIG. 4B, the protection plate 124 of the first panel 120 has a first surface 124a and a second surface 124b opposite to the first surface 124a. The first surface 124a is located between the display device 110 and the second surface 124b. The second positioning parts 122 (i.e., the recesses) penetrate the first surface 124a and extend toward the second surface 124b. In the present embodiment, the second positioning parts 122 do not penetrate the second surface 124b. Each of the second positioning parts 122 includes a third positioning sub-part 122a and a fourth positioning sub-part 122b. The third positioning sub-part 122a is located between the fourth positioning sub-part 122b and the display device 110. The maximum caliber d3 of the fourth positioning sub-part 122b is greater than the maximum caliber d4 of the third positioning sub-part 122a. Namely, in the present embodiment, the third positioning sub-part 122a may be a cylindrical recess with the small diameter and large thickness, while the fourth positioning sub-part 122b may be a recess shaped as a circulate plate and having the large diameter and small thickness.

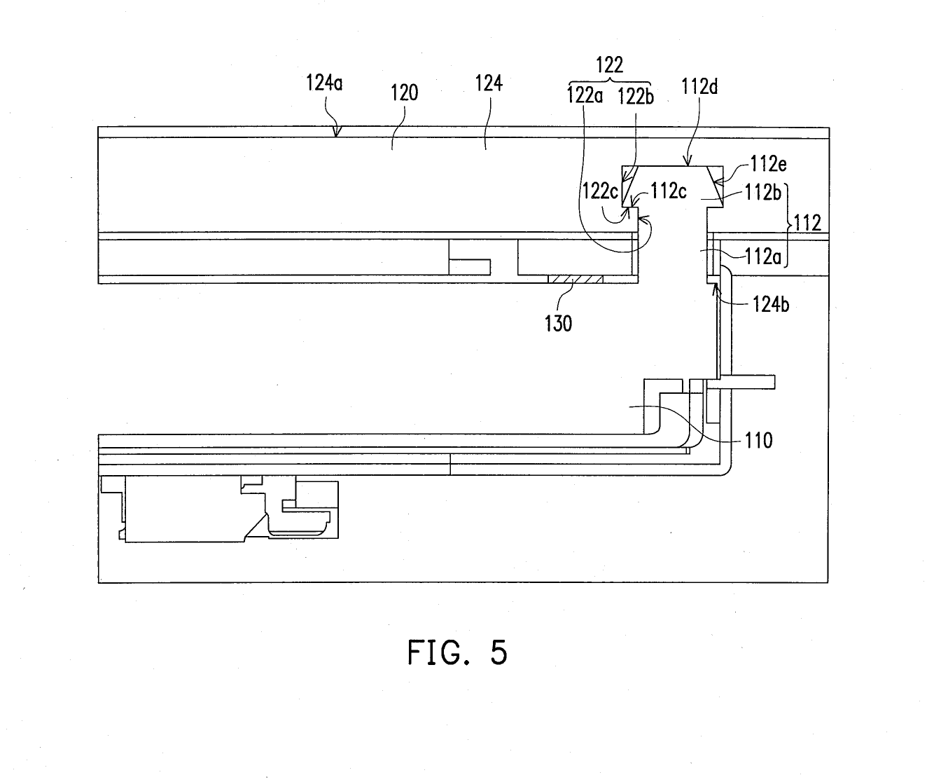

FIG. 5 is a cross-sectional view taken along a line segment I-I′ depicted in FIG. 1A. With reference to FIG. 5, after the first panel 120 is completely assembled to the display device 110, the first positioning sub-part 112a of the first positioning part 112 is lodged in the third positioning sub-part 122a of the second positioning part 122, and the second positioning sub-part 112b is lodged in the fourth positioning sub-part 122b. The bottom surface 112c of the second positioning sub-part 112b and a surface 122c of the fourth positioning sub-part 122b can prevent the first positioning parts 112 from dislodging from the second positioning parts 122. Thereby, the first positioning parts 112 and the second positioning parts 122 may be stably combined, so as to fix relative locations of the first panel 120 and the display device 110.

Besides, in order to enhance the combination of the first panel 120 and the display device 110, the touch display module 100 described herein may further include an adhesive 130. As shown in FIG. 1B and FIG. 5, the adhesive 130 may be disposed between the display device 110 and the first panel 120, such that the first panel 120 may be better adhered to the display device 110. In the present embodiment, the adhesive 130 is a double-sided tape, a hydro-gel, a combination thereof, or any other appropriate adhesive.

It should be mentioned that the first positioning parts and the second positioning parts are not structurally limited to be protrusions and recesses with two sub-parts. Any structure that may be formed on the first panel and the display device and may fix the relative locations of the first panel and the display device may serve as the positioning part described herein. Several embodiments are further provided hereinafter to describe the possible variations in the structure of the aforesaid positioning parts.

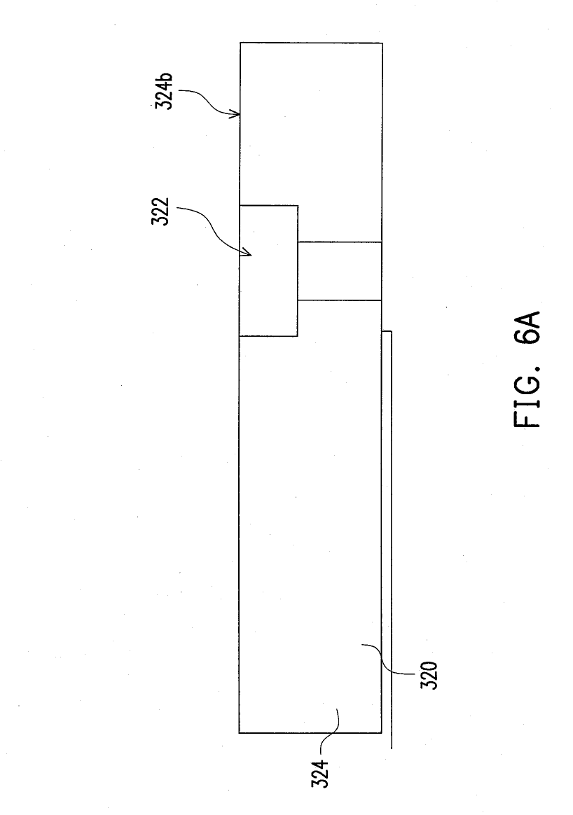

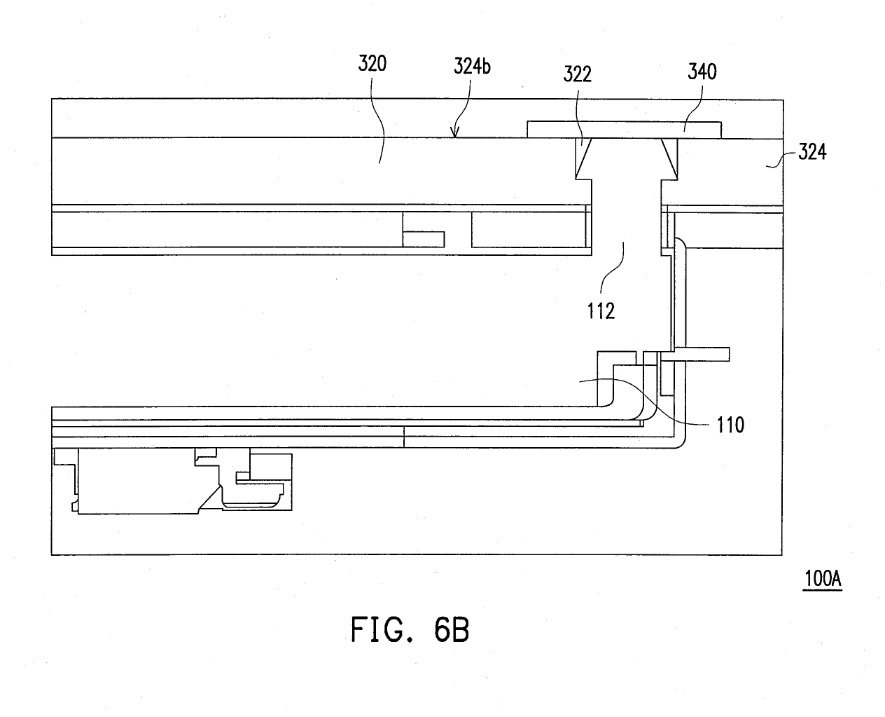

As illustrated in FIG. 4B, the second positioning parts 122 described above do not penetrate the protection plate 124. Therefore, after the first panel 120 is assembled to the display device 110, there is no open hole on the surface of the protection plate 124. However, in other embodiments of the invention, the first panel may be required to reduce its thickness. At this time, the second positioning parts 122 may penetrate the protection plate 124 in order to ensure that the positioning structures of the first panel and the display device are effectively formed, shaped, and functioned. FIG. 6A is a cross-sectional view illustrating a touch display module according to yet another embodiment of the invention. FIG. 6B is a cross-sectional view illustrating that the first panel depicted in FIG. 6A is assembled to a display device. The difference between the touch display device 100A shown in FIG. 6B and the touch display device 100 shown in FIG. 5 lies in that the second positioning parts 322 of the first panel 320 may penetrate the protection plate 324, as shown in FIG. 6A and FIG. 6B. When the first panel 320 is assembled to the display device 110, the second positioning parts 322 and the first positioning parts 112 may still be locked and positioned. Note that the second positioning parts 322 may penetrate the protection plate 324, and hence the touch display device 100A described in the present embodiment may further include a plurality of shields 340. The shields 340 are disposed on the second surface 324b of the protection plate 324, and the shields 340 respectively cover the second positioning parts 322. As such, the second positioning parts 322 are not apt to smear the appearance of the touch display device 100A. The shields 340 may be mylar made of plastic, which should however not be construed as a limitation to the invention.

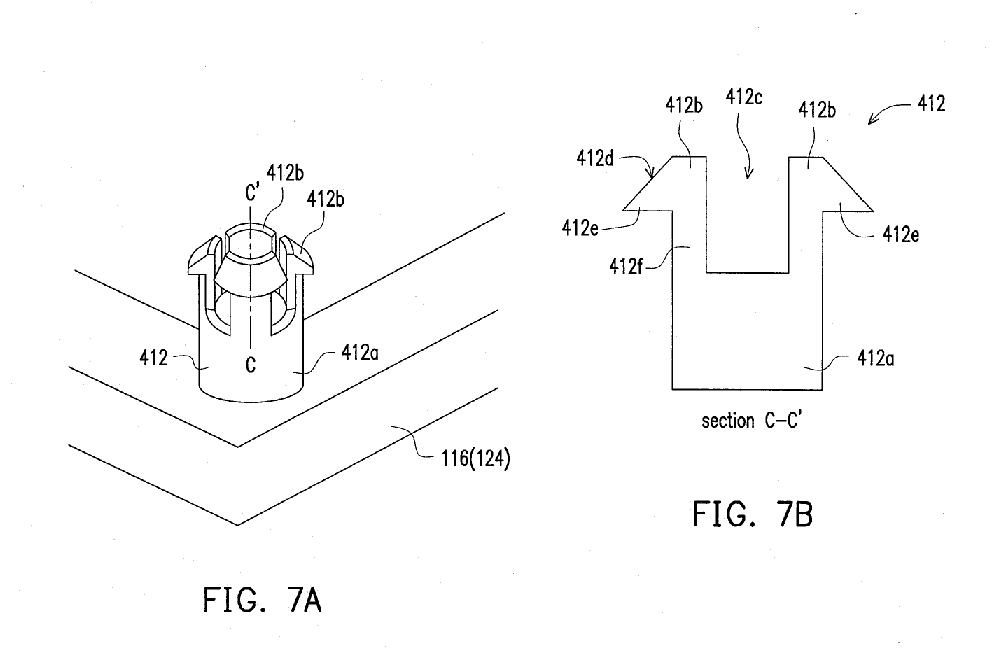

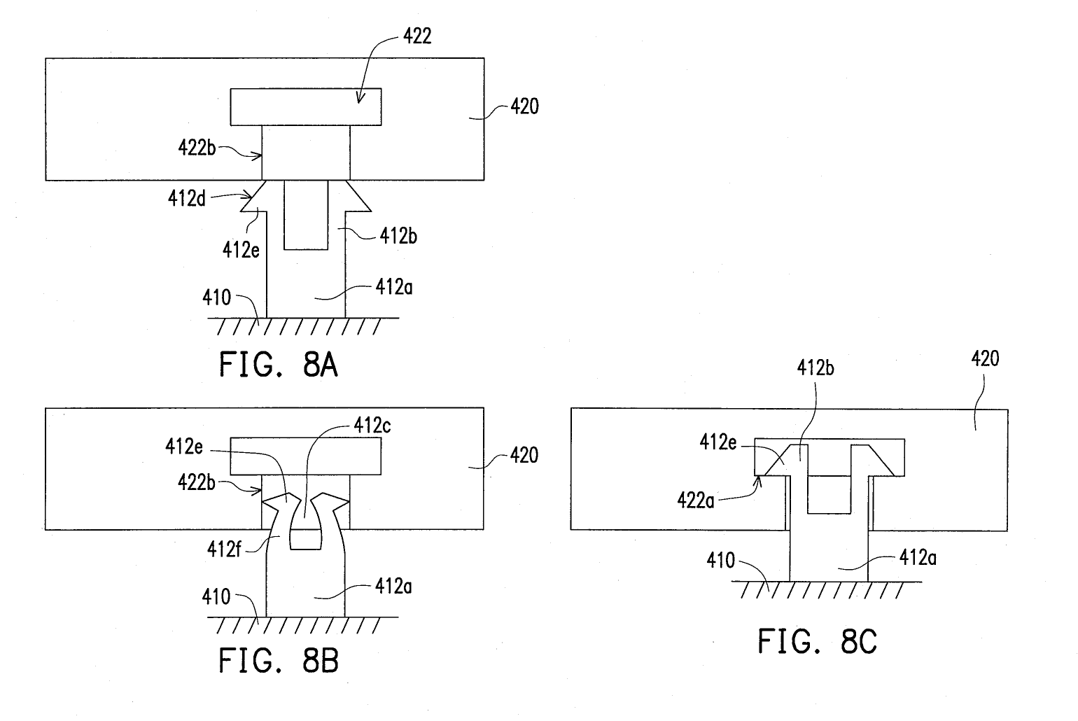

Another embodiment will be provided hereinafter to explain the condition that at least one of the positioning parts is a protrusion. FIG. 7A is a cross-sectional view illustrating a touch display module according to yet another embodiment of the invention. FIG. 7B is a cross-sectional view taken along a line segment C-C′ in FIG. 7A. To clearly illustrate the invention, the first panel is omitted in FIG. 7A and FIG. 7B. FIG. 8A to FIG. 8C are cross-sectional views illustrating a process of assembling the first panel to the display device depicted in FIG. 7A. With reference to FIG. 7A and FIG. 7B, in the present embodiment, the first positioning parts 412 may be protrusions, and the second positioning parts 422 may be recesses, for instance. The recesses are similar to those described above, and therefore no further descriptions are provided hereinafter. According to the present embodiment, each of the first positioning parts 412 includes a base 412a and a plurality of fasteners 412b connected to the base 412a. At least one flexible space 412c exists among the fasteners 412b.

In particular, each fastener 412b may have an inclined surface 412d, a protruding portion 412e, and an elastic arm 412f. The protruding portion 412e and the surface 422a of the second positioning part 422 is suitable for preventing the first positioning part 412 from dislodging from the second positioning part 422 when the first panel 420 is locked to the display device 410. The elastic arm 412f connects the protruding portion 412e and the base 412a. Besides, the elastic arm 412f is capable of storing elastic potential energy without generating permanent deformation, such that the fastener 412b is driven to return to its original location. As illustrated in FIG. 8A, when the first panel 420 starts to be assembled to the display device 410, the fasteners 412b start to enter the second positioning parts 422 on the first panel 420. In FIG. 8B, when the fasteners 412b enter the second positioning parts 422, the inclined surface 412d and the protruding portion 412e of each fastener 412b may be pressed by the sidewalls 422b of the second positioning parts 422. At this time, the elastic arms 412f are bent, such that the elastic space 412c among the fasteners 412b is reduced. Here, the elastic arms 412f may store the elastic potential energy. In FIG. 8C, when the fasteners 412b are no longer pressed by the recessive sidewalls 422b, the elastic arms 412f drive the fasteners 412b to return to the original location. Additionally, the protruding portions 412e and the surfaces 422a of the second positioning parts 422 can prevent the first positioning parts 412 from dislodging from the first panel 420, so as to fix the relative locations of the first panel 420 and the display device 410.

To sum up, during assembly of the touch display module described herein, abnormal alignment between the first panel and the display device is not prone to occur if the first positioning parts and the second positioning parts are applied, and thereby the assembly yield of the touch display module described herein may be improved. Moreover, through the first positioning parts and the second positioning parts, manufacturers need not spend time adjusting the conventional positioning fixtures, such that the labor hours required for assembling the touch display module can be effectively reduced.

Although the invention has been described with reference to the embodiments thereof, it will be apparent to one of the ordinary skills in the art that modifications to the described embodiments may be made without departing from the spirit of the invention. Accordingly, the scope of the invention will be defined by the attached claims not by the above detailed description.

What is claimed is:

1. A touch display module comprising:
a display device comprising a display panel, a frame surrounding the display panel, and at least two first positioning parts disposed on the frame; and
a first panel disposed on the display device, the first panel comprising a protection plate and at least two second positioning parts disposed on the protection plate, wherein the at least two first positioning parts are respectively combined with the at least two second positioning parts, so as to fix relative locations of the first panel and the display device.

2. The touch display module as recited in claim 1, wherein the first positioning parts are a plurality of protrusions extending toward the first panel, and the second positioning parts are a plurality of recesses corresponding to the protrusions.

3. The touch display module as recited in claim 2, wherein the first panel further comprises a touch sensing layer located between the protection plate and the display device.

4. The touch display module as recited in claim 2, wherein the display panel comprises an active device substrate, an opposite substrate opposite to the active device substrate, a display medium layer located between the active device substrate and the opposite substrate, and a touch sensing layer located between the opposite substrate and the display medium layer.

5. The touch display module as recited in claim 2, wherein the display panel comprises an active device substrate, an opposite substrate opposite to the active device substrate, a display medium layer located between the active device substrate and the opposite substrate, and a touch sensing layer, and the opposite substrate is located between the touch sensing layer and the display medium layer.

6. The touch display module as recited in claim 2, wherein the display panel comprises an active device substrate, an opposite substrate opposite to the active device substrate, a display medium layer located between the active device substrate and the opposite substrate, and a touch sensing layer located between the active device substrate and the display medium layer.

7. The touch display module as recited in claim 2, wherein the protection plate has a first surface and a second surface opposite to the first surface, the first surface is located between the display device and the second surface, the recesses penetrate the first surface and extend toward the second surface, but the recesses do not penetrate the second surface.

8. The touch display module as recited in claim 2, wherein the recesses penetrate the protection plate.

9. The touch display module as recited in claim 8, further comprising a plurality of shields disposed on the second surface of the protection plate, and the shields respectively cover the recesses.

10. The touch display module as recited in claim 2, wherein each of the first positioning parts comprises a first positioning sub-part and a second positioning sub-part, the first positioning sub-part connects the second positioning sub-part and the frame, and a maximum diameter of the second positioning sub-part is greater than a maximum diameter of the first positioning sub-part.

11. The touch display module as recited in claim 10, wherein the first positioning sub-part is a pillar, the second positioning sub-part has a bottom surface directly connected to the pillar, a top surface opposite to the bottom surface, and a circumferential surface surrounding and connecting the top surface and the bottom surface, an area of the bottom surface is greater than an area of the top surface, a cross-sectional area of the pillar cut by a reference plane is smaller than the area of the bottom surface, and the reference plane is parallel to a display surface of the display device.

12. The touch display module as recited in claim 11, wherein a cross-sectional area of the second positioning sub-part cut by the reference plane is gradually reduced together with the reference plane moving away from the display device.

13. The touch display module as recited in claim 10, wherein each of the second positioning parts comprises a third positioning sub-part and a fourth positioning sub-part, the third positioning sub-part is located between the fourth positioning sub-part and the display device, and a maximum caliber of the fourth positioning sub-part is greater than a maximum caliber of the third positioning sub-part.

14. The touch display module as recited in claim 13, wherein the first positioning sub-part is lodged in the third positioning sub-part, and the second positioning sub-part is lodged in the fourth positioning sub-part.

15. The touch display module as claimed in claim 2, wherein each of the first positioning parts comprises a base and a plurality of fasteners connected to the base, and at least one flexible space exists among the fasteners.

16. The touch display module as recited in claim 15, wherein each of the second positioning parts comprises a third positioning sub-part and a fourth positioning sub-part, the third positioning sub-part is located between the fourth positioning sub-part and the display device, and a maximum caliber of the fourth positioning sub-part is greater than a maximum caliber of the third positioning sub-part.

17. The touch display module as recited in claim 16, wherein the base is lodged in the third positioning sub-part, and the fasteners are lodged in the fourth positioning sub-part.

18. The touch display module as recited in claim 1, wherein the first positioning parts are recesses extending toward the first panel, and the second positioning parts are protrusions corresponding to the recesses.

19. The touch display module as claimed in claim 1, further comprising an adhesive disposed between the display device and the first panel, the adhesive being suitable for adhering the first panel to the display device.

20. The touch display module as claimed in claim 19, wherein the adhesive is a double-sided tape, a hydro-gel, or a combination thereof.
